(19) United States
(12) Patent Application Publication
(10) Pub. No.: US 2025/0304748 A1
(43) Pub. Date: Oct. 2, 2025

(54) RESIN COMPOSITION, DRY FILM, AND CURED PRODUCT

(71) Applicant: TAIYO HOLDINGS CO., LTD., Hiki-gun (JP)

(72) Inventors: Takumi SUZUKI, Hiki-gun (JP); Mami NOSAKA, Hiki-gun (JP); Yoshitomo AOYAMA, Hiki-gun (JP); Kota OKI, Hiki-gun (JP); Kasumi HASHIMOTO, Hiki-gun (JP); Yumi KONDO, Hiki-gun (JP); Daichi OKAMOTO, Hiki-gun (JP)

(21) Appl. No.: 19/081,058

(22) Filed: Mar. 17, 2025

(30) Foreign Application Priority Data
Mar. 26, 2024 (JP) 2024-050009

(51) Int. Cl. C08G 65/44; C08J 5/18

(52) U.S. Cl. CPC C08G 65/44; C08J 5/18; C08J 2371/12

(57) ABSTRACT

The resin composition contains (A) a branched polyphenylene ether, (B) a curing agent component, (C) a radical polymerization initiator, and (D) a filler, in which the curing agent component (B) has two or more styrene double bonds and has a molecular weight of 2,500 or less.

### CROSS-REFERENCE TO RELATED APPLICATIONS

This application claims priority based on Japanese Patent Application No. 2024-050009, filed with the Japan Patent Office on Mar. 26, 2024, and the entire disclosure thereof is fully incorporated herein by reference.

### TECHNICAL FIELD

The present invention relates to a resin composition, a dry film, and a cured product.

### RELATED ART

In recent years, with the spread of large-capacity high-speed communication represented by the fifth generation communication system (5G), millimeter wave radars for an advanced driver assistance system (ADAS) of automobiles, and the like, the frequencies of signals for electronic devices have been increased.

For a printed wiring board built in such an electronic device, a curable resin composition containing an epoxy resin or the like as a main component has been used as an interlayer insulating material. A cured product including such a composition has a high relative permittivity (Dk) and a high dielectric loss tangent (Df), and has increased transmission loss with respect to signals in a high frequency band, causing problems such as signal attenuation and heat generation. Therefore, polyphenylene ethers excellent in low dielectric properties have attracted attention.

For example, Patent Literature 1 proposes a polyphenylene ether-containing curable composition that contains silica in a curable composition to improve film formability of the composition and has excellent low dielectric properties and low thermal expansion rate.

### CITATION LIST

### Patent Literature

Patent Literature 1: JP 2021-54974 A

### SUMMARY OF INVENTION

### Technical Problem

However, in the technique of Patent Literature 1, since the curable composition contains silica at a high blending ratio, silica is likely to fall off at the interface between plating and an insulating (cured product) layer, and plating adhesion is low, so that there has been a problem that plating swelling (swelling) occurs. The plating swelling refers to a phenomenon in which a part of the insulating layer is released from the substrate in the plating step.

Therefore, an object of the present invention is to provide a resin composition which has excellent film formability and can suppress plating swelling while maintaining low dielectric properties and low thermal expansion rate; a dry film including a resin layer formed of the resin composition; and a cured product obtained using the resin layer of the dry film.

### Solution to Problem

One aspect of the present invention is a resin composition. The resin composition preferably contains (A) a branched polyphenylene ether, (B) a curing agent component, (C) a radical polymerization initiator, and (D) a filler, wherein the curing agent component (B) preferably has two or more styrene double bonds and preferably has a molecular weight of 2,500 or less.

In the resin composition of the above aspect, the curing agent component (B) preferably has two or more styrene double bonds, and the curing agent component (B) preferably has a molecular weight of 200 to 1,500.

In the resin composition of the above aspect, the curing agent component (B) preferably has two styrene double bonds, and the curing agent component (B) preferably has a molecular weight of 200 to 1,500.

In the resin composition of the above aspect, the curing agent component (B) is preferably a compound represented by the following formula (1):

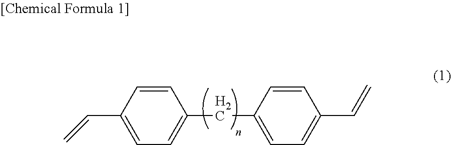

wherein n is an integer of 1 to 10.

Another aspect of the present invention is a dry film. The dry film preferably includes a resin layer formed of the resin composition of the above aspect.

Another aspect of the present invention is a cured product. The cured product is preferably obtained using the resin composition of the above aspect or the resin layer of the dry film of the above aspect.

### Advantageous Effects of Invention

According to the present invention, a resin composition which has excellent film formability and can suppress plating swelling while maintaining low dielectric properties and low thermal expansion rate; a dry film including a resin layer formed of the resin composition; and a cured product obtained using the resin layer of the dry film can be provided.

### DETAILED DESCRIPTION

Hereinafter, embodiments of the present invention will be described in detail. The expression “a to b” used herein for the description of the numerical range means a or more and b or less unless otherwise specified.

When isomers are present in the compounds described, all isomers that may be present are usable in the present invention unless otherwise indicated.

In the present specification, phenols that can be used as raw materials of polyphenylene ether (PPE) and can serve as constitutional units of the polyphenylene ether are collectively referred to as “raw material phenols”.

In the present specification, when raw material phenols are expressed as “ortho position”, “para position”, or the like, unless otherwise specified, the position of the phenolic hydroxyl group is used as a reference (ipso position).

In the present specification, when simply expressed as “ortho position” or the like, “at least one of ortho positions” or the like is indicated. Therefore, as long as there is no particular contradiction, the term “ortho position” may be interpreted as indicating either one of the ortho positions or may be interpreted as indicating both of the ortho positions.

In the present specification, a polyphenylene ether in which some or all functional groups (for example, a hydroxyl group) of the polyphenylene ether are modified may be simply referred to as a “polyphenylene ether”. Therefore, the phrase “polyphenylene ether” includes both an unmodified polyphenylene ether and a modified polyphenylene ether unless there is a particular contradiction.

In the present specification, monovalent phenols are mainly disclosed as the raw material phenols, but polyvalent phenols may be used as the raw material phenols as long as the effect of the present invention is not inhibited.

In the present specification, when the upper limit value and the lower limit value of the numerical range are described separately, all combinations of each lower limit value and each upper limit value are substantially described within a range that does not contradict each other.

In the present specification, the solid content is used to mean a nonvolatile content (a component other than a volatile component such as a solvent).

In the present specification, the components contained in the resin composition and the components contained in the resin layer that is a dry coating film of the resin composition may be described without distinction.

The weight average molecular weight (number average molecular weight) can be measured using a known measurement method, for example, a gel permeation chromatography (GPC) method as a polystyrene equivalent molecular weight.

### 1. Resin Composition

The resin composition of the present embodiment contains (A) a branched polyphenylene ether, (B) a curing agent component, (C) a radical polymerization initiator, and (D) a filler. In addition, the resin composition may contain other components as long as the effect of the present invention is not impaired. Each component will be described below.

### 1-1. (a) Branched Polyphenylene Ether (Branched PPE)

The branched polyphenylene ether (A) of the present embodiment is obtained from raw material phenols including phenols satisfying at least the following condition.

### (Condition)

Having a hydrogen atom at an ortho position and a para position.

The phenols satisfying the above condition have a hydrogen atom at the ortho position, and thus an ether bond can be formed not only at the ipso position and the para position but also at the ortho position when oxidatively polymerized with the phenols, so that the polyphenylene ether obtained using such phenols as raw material phenols can form a branched chain structure. That is, a part of the structure of the branched polyphenylene ether (A) is branched by a benzene ring in which at least three positions of an ipso position, an ortho position, and a para position are ether-bonded.

Examples of the branched polyphenylene ether (A) include a polyphenylene ether disclosed in WO 2020/017570 A.

The branched polyphenylene ether (A) may be obtained by either of (Method 1) a method of synthesizing a polyphenylene ether using phenols containing a functional group having an unsaturated carbon bond as raw material phenols, or (Method 2) a method of synthesizing a polyphenylene ether using phenols not containing a functional group having an unsaturated carbon bond as raw material phenols, and modifying the obtained polyphenylene ether to introduce a functional group having an unsaturated carbon bond into the polyphenylene ether.

The branched polyphenylene ether (A) of the present embodiment may be a mixture of two or more polyphenylene ethers having different kinds of raw material phenols. In addition, other phenols not satisfying the above condition may be contained as long as the effect of the present invention is not impaired.

The branched polyphenylene ether (A) of the present embodiment has a functional group containing an unsaturated carbon bond. The unsaturated carbon bond indicates an ethylenic or acetylenic carbon-carbon multiple bond (double bond or triple bond). The functional group having an unsaturated carbon bond is not particularly limited, and is preferably an alkenyl group (for example, a vinyl group, an allyl group), an alkynyl group (for example, an ethynyl group), or a (meth)acryloyl group, more preferably a vinyl group, an allyl group, or a (meth)acryloyl group from the viewpoint of excellent curability, and still more preferably an allyl group from the viewpoint of excellent low dielectric properties. The number of carbon atoms of these functional groups having an unsaturated carbon bond may be, for example, 15 or less, 10 or less, 8 or less, 5 or less, or 3 or less.

The equivalent of the functional group having an unsaturated carbon bond in the branched polyphenylene ether (A) of the present embodiment can be appropriately changed according to the curability, application, and the like of the resin composition.

The branched polyphenylene ether (A) of the present embodiment has a weight average molecular weight (Mw) of preferably 1,000 or more, 1,500 or more, 2,000 or more, or the like, and preferably 150,000 or less, 100,000 or less, 80,000 or less, or the like.

The polydispersity index {PDI: weight average molecular weight (Mw)/number average molecular weight (Mn)} of the branched polyphenylene ether (A) of the present embodiment is preferably 1.5 to 20.

The amount of the branched polyphenylene ether (A) of the present embodiment added is, for example, preferably 5% by mass or more, 10% by mass or more, 15% by mass or more, 20% by mass or more, or the like, and preferably 60% by mass or less, 50% by mass or less, or 45% by mass or less, or the like, based on the total solid content of the resin composition.

### 1-2. (B) Curing Agent Component

The curing agent component (B) of the present embodiment has two or more styrene double bonds. When the curing agent component (B) has two or more styrene double bonds, the affinity with the branched polyphenylene ether (A) is relatively high, and the curing reaction easily proceeds, so that a resin composition having excellent low dielectric properties and low thermal expansion rate can be obtained.

The curing agent component (B) of the present embodiment has a molecular weight (number average molecular weight) of 2,500 or less. By setting the molecular weight of the curing agent component (B) to 2,500 or less, a molecular chain having an appropriate length is obtained, and the fluidity of the resin composition can be improved.

The curing agent component (B) of the present embodiment is not limited as long as it has two or more styrene double bonds, and a known curing agent component can be used. The styrene double bond preferably has 2 to 4 bonds, and more preferably has 2 bonds. Examples thereof include compounds represented by the following formula (1), divinylfluorene, divinylbiphenyl, divinylnaphthalene, divinylbenzene, and oligophenylene ether compounds with terminal styrene. Among these, the compounds represented by the following formula (1) are more preferable.

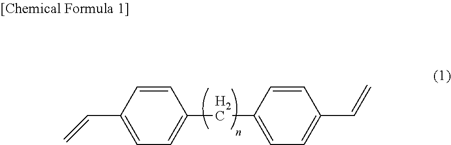

wherein n is an integer of 1 to 10.

In the above formula (1), n is preferably an integer of 1 to 10, more preferably an integer of 1 to 8, and still more preferably an integer of 1 to 5. From the viewpoint of fluidity of the resin composition, n is particularly preferably 2. In the above formula (1), the compound {1,2-bis(vinylphenyl) ethane (BVPE)} in which n is 2 is shown in the following formula (2). The curing agent component (B) of the present embodiment may be used alone or in combination of two or more.

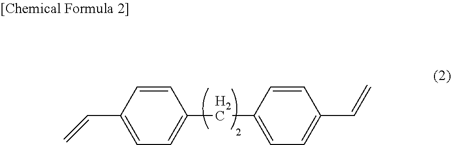

The molecular weight of the curing agent component (B) of the present embodiment is preferably 2,500 or less, 2,000 or less, 1,500 or less, or the like. In addition, it is preferably 100 or more, 150 or more, 200 or more, or the like. When the molecular weight of the curing agent component is within the above range, the fluidity of the resin composition can be improved while volatilization of the curing agent component (B) is suppressed. In addition, it is possible to suppress a decrease in film thickness (film thinning) in a step of producing the cured product described later (during thermal curing).

The amount of the curing agent component (B) of the present embodiment added is, for example, preferably 0.1% by mass or more, 0.5% by mass or more, 1% by mass or more, 3% by mass or more, or the like, and preferably 40% by mass or less, 30% by mass or less, 25% by mass or less, or the like, based on the total solid content of the resin composition.

The blending ratio of the curing agent component (B) with respect to 100 parts by mass of the branched PPE (A) of the present embodiment is preferably 1 part by mass or more, 10 parts by mass or more, or the like, and preferably 67 parts by mass or less, 55 parts by mass or less, or the like. By setting the blending ratio of the branched PPE (A) and the curing agent component (B) in the above range, it is possible to obtain a resin composition capable of suppressing plating swelling while maintaining low dielectric properties and low thermal expansion rate.

### 1-3. (C) Radical Polymerization Initiator

The radical polymerization initiator (C) of the present embodiment is a compound capable of easily forming a polymer by generating active species (also referred to as free radicals) by heat or ultraviolet rays and polymerizing the radically polymerizable monomer. The radical polymerization initiator (C) is not particularly limited as long as the effect of the invention is not impaired, and a photoradical polymerization initiator, a thermal radical polymerization initiator, and the like can be used. The radical polymerization initiator can be used singly or in combination of two or more. Hereinafter, the radical polymerization initiator will be described in detail.

### <Thermal Radical Polymerization Initiator>

The thermal radical polymerization initiator is not particularly limited, and examples thereof include azo-based polymerization initiators (for example, 2,2′-azobisisobutyronitrile, 2,2′-azobis-2-methylbutyronitrile, 2,2′-azobis(2-methylpropionic acid)dimethyl, 4,4′-azobis-4-cyanovaleric acid, azobisisovaleronitrile, 2,2′-azobis(2-amidinopropane) dihydrochloride, 2,2′-azobis [2-(5-methyl-2 imidazolin-2-yl) propane]dihydrochloride, 2,2′-azobis(2-methylpropionamidine)disulfate, and 2,2′-azobis(N,N′-dimethylene isobutyramidine) dihydrochloride); peroxide-based polymerization initiators (for example, dibenzoyl peroxide, t-butyl permaleate, and lauroyl peroxide); and redox-based polymerization initiators.

### <Photoradical Polymerization Initiator>

The photoradical polymerization initiator is not particularly limited, and examples thereof include benzoin ether-based photopolymerization initiators, acetophenone-based photopolymerization initiators, α-ketol-based photopolymerization initiators, aromatic sulfonyl chloride-based photopolymerization initiators, photoactive oxime-based photopolymerization initiators, benzoin-based photopolymerization initiators, benzyl-based photopolymerization initiators, benzophenone-based photopolymerization initiators, ketal-based photopolymerization initiators, thioxanthone-based photopolymerization initiators, and acylphosphine oxide-based photopolymerization initiators.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one [trade name: Omnirad651, manufactured by IGM Resins], and anisoin.

Examples of the acetophenone-based photopolymerization initiator include 1-hydroxycyclohexyl phenyl ketone [trade name: Omnirad184, manufactured by IGM Resins], 4-phenoxydichloroacetophenone, 4-t-butyl-dichloroacetophenone, 1-[4-(2-hydroxyethoxy)-phenyl]-2-hydroxy-2-methyl-1-propan-1-one [trade name: Omnirad2959, manufactured by IGM Resins], 2-hydroxy-2-methyl-1-phenyl-propan-1-one [trade name: Omnirad1173, manufactured by IGM Resins], and methoxyacetophenone.

Examples of the α-ketol-based photopolymerization initiator include 2-methyl-2-hydroxypropiophenone and 1-[4-(2-hydroxyethyl)-phenyl]-2-hydroxy-2-methylpropan-1-one.

Examples of the aromatic sulfonyl chloride-based photopolymerization initiator include 2-naphthalenesulfonyl chloride. Examples of the photoactive oxime-based photopolymerization initiator include 1-phenyl-1,2-propanedione-2-(O-ethoxycarbonyl)-oxime.

Examples of the benzoin-based photopolymerization initiator include benzoin. Examples of the benzyl-based photopolymerization initiator include benzyl. Examples of the benzophenone-based photopolymerization initiator include benzophenone, benzoylbenzoic acid, 3,3′-dimethyl-4-methoxybenzophenone, polyvinyl benzophenone, and α-hydroxycyclohexyl phenyl ketone.

Examples of the ketal-based photopolymerization initiator include benzyl dimethyl ketal. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Examples of the acylphosphine-based photopolymerization initiator include bis(2,6-dimethoxybenzoyl)phenylphosphine oxide, bis(2,6-dimethoxybenzoyl) (2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl) octylphosphine oxide, bis(2-methoxybenzoyl) (2-methylpropan-1-yl)phosphine oxide, bis(2-methoxybenzoyl) (1-methylpropan-1-yl) phosphine oxide, bis(2,6-diethoxybenzoyl) (2-methylpropan-1-yl) phosphine oxide, bis(2,6-diethoxybenzoyl) (1-methylpropan-1-yl) phosphine oxide, bis(2,6-dibutoxybenzoyl) (2-methylpropan-1-yl) phosphine oxide, bis(2,4-dimethoxybenzoyl) (2-methylpropan-1-yl) phosphine oxide, bis(2,4,6-trimethylbenzoyl) (2,4-dipentoxyphenyl) phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoylbenzylbutylphosphine oxide, 2,6-dimethoxybenzoylbenzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl) isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis [bis(2,4,6-trimethylbenzoyl) phosphine oxide]decane, and tri (2-methylbenzoyl) phosphine oxide.

The amount of the radical polymerization initiator (C) added can be 0.01 to 3.0% by mass based on the total solid content of the resin composition.

### 1-4. (D) Filler

The filler (D) of the present embodiment contributes to adjustment of physical properties and permittivity of the cured product described later. Examples of the filler (D) include inorganic fillers such as silica, glass fiber, and calcium carbonate, and organic fillers such as PTFE powder.

### <Inorganic Filler>

As the inorganic filler, a metal oxide such as alumina or titanium oxide; a metal hydroxide such as aluminum hydroxide or magnesium hydroxide; a clay mineral such as talc or mica; a filler having a perovskite-type crystal structure such as barium titanate or strontium titanate; silica, boron nitride, aluminum borate, barium sulfate, calcium carbonate, or the like can be used.

Of the above-described inorganic fillers, silica improves the film formability of the resin composition, and can realize a low dielectric loss tangent and a low thermal expansion at a high level.

The silica has an average particle size of preferably 0.02 to 10 μm, and more preferably 0.02 to 3 μm. Here, the average particle size can be determined as a median diameter (d50, based on volume) by a cumulative distribution from a measured value of a particle size distribution by a laser diffraction/scattering method using a commercially available laser diffraction/scattering type particle size distribution measuring apparatus. In addition, the average particle size of silica refers to a value obtained by measuring a powdery material before preparing (pre-stirring and kneading) the resin composition as described above.

Silicas having different average particle sizes can also be used in combination. From the viewpoint of highly filling the silica, for example, minute silica of nano-order having an average particle size of less than 1 μm may be used in combination with silica having an average particle size of 1 μm or more.

The silica may be surface-treated with a coupling agent. By treating the surface with a silane coupling agent, dispersibility with the polyphenylene ether can be improved. In addition, the affinity with an organic solvent can also be improved.

As the silane coupling agent, for example, an epoxysilane coupling agent, a mercaptosilane coupling agent, a vinylsilane coupling agent, or the like can be used. As the epoxysilane coupling agent, for example, γ-glycidoxypropyltrimethoxysilane, γ-glycidoxypropylmethyldimethoxysilane, or the like can be used. As the mercaptosilane coupling agent, for example, γ-mercaptopropyltriethoxysilane or the like can be used. As the vinylsilane coupling agent, for example, vinyltriethoxysilane or the like can be used.

The amount of the silane coupling agent used may be, for example, 0.1 to 5 parts by mass or 0.5 to 3 parts by mass relative to 100 parts by mass of silica.

The amount of the filler (D) such as silica added may be 30 to 80% by mass based on the total solid content of the resin composition. By setting the amount of the filler added within the above-mentioned range, when preparing the dry film described later from the resin composition, warpage of the dry film can be reduced.

### 1-5. Other Components

As other components, known components such as flame retardant improvers (phosphorus compounds and the like), cellulose nanofibers, cyanate ester resins, epoxy resins, phenol novolac resins, elastomers, dispersants, curing accelerators, crosslinkable curing agents (crosslinking agents, crosslinking aids), adhesion imparting agents, and solvents may be contained.

### <Crosslinkable Curing Agent>

As the crosslinkable curing agent (crosslinking agent, crosslinking aid), one having good compatibility with polyphenylene ether is used, and vinyl benzyl ether-based compounds synthesized from reaction of phenol and vinyl benzyl chloride; allyl ether-based compounds synthesized from reaction of styrene monomer, phenol, and allyl chloride; further, trialkenyl isocyanurate and the like have good compatibility.

More specifically, trialkenyl isocyanurate having particularly good compatibility with polyphenylene ether is preferable, and among these, specifically, triallyl isocyanurate (hereinafter, TAIC (registered trademark)) and triallyl cyanurate (hereinafter, TAC) are preferable. These exhibit low dielectric properties and can enhance heat resistance. TAIC (registered trademark) is particularly preferable because of excellent compatibility with polyphenylene ether. The crosslinkable curing agent may be used alone or in combination of two or more.

Since the branched polyphenylene ether (A) of the present embodiment contains a hydrocarbon group having an unsaturated carbon bond, a cured product having excellent low dielectric properties can be obtained particularly by curing the branched polyphenylene ether (A) with a crosslinkable curing agent.

The amount of the crosslinkable curing agent added may be 3 to 25% by mass based on the total solid content in the resin composition. Within the above range, a cured product having excellent low dielectric properties and low thermal expansion rate can be obtained.

### <Solvent>

The resin composition of the present invention is usually provided or used in a state in which the branched polyphenylene ether (A) is dissolved in a solvent.

Examples of the solvent that can be used in the resin composition of the present embodiment include solvents with relatively high safety, such as N-methyl-2-pyrrolidone (NMP), tetrahydrofuran (THF), cyclohexanone, propylene glycol monomethyl ether acetate (PMA), diethylene glycol monoethyl ether acetate (CA), methyl ethyl ketone, and ethyl acetate, in addition to conventionally usable solvents such as chloroform, methylene chloride, and toluene. The solvent may be N,N-dimethylformamide (DMF). The solvent may be used alone or in combination of two or more.

The amount of the solvent added in the resin composition of the present embodiment is not particularly limited, and can be appropriately adjusted according to the application of the resin composition.

### 2. Dry Film

The dry film of the present embodiment can be produced by applying the resin composition of the present embodiment to a first film (for example, a carrier film) and drying it to form a resin layer as a dry coating film. A second film (for example, a protective film) can be laminated on the resin layer as necessary. That is, the dry film of the present embodiment includes a resin layer formed of a resin composition.

The first film plays a role of supporting the resin layer of the dry film, and refers to a film that is bonded to at least the resin layer when the resin layer is laminated on a base material such as a substrate by heating or the like so that the resin layer side of the dry film is in contact with the base material and integrally molded. As the first film, for example, a polyester film such as polyethylene terephthalate or polyethylene naphthalate, a film made of a thermoplastic resin such as a polyimide film, a polyamideimide film, a polyethylene film, a polytetrafluoroethylene film, a polypropylene film, or a polystyrene film, surface-treated paper, or the like can be used. Of these, a polyester film can be suitably used from the viewpoint of heat resistance, mechanical strength, handleability, and the like. The thickness of the first film is not particularly limited, and is appropriately selected in a range of about 10 to 150 μm according to the application. The surface of the first film on which the resin layer is provided may be subjected to release treatment. In addition, sputtering or a copper foil may be formed on the surface of the first film on which the resin layer is provided.

The second film is provided on a surface of the resin layer opposite to the first film for the purpose of preventing adhesion of dust or the like to the surface of the resin layer of the dry film and improving handleability. The second film is peeled off from the resin layer before lamination when the resin layer is laminated on the base material by heating or the like so that the resin layer side of the dry film is in contact with the base material such as a substrate; and integrally molded. As the second film, for example, a film made of the thermoplastic resin exemplified in the first film, surface-treated paper, and the like can be used, and of these, a polyester film, a polyethylene film, and a polypropylene film are preferable. The thickness of the second film is not particularly limited, and is appropriately selected in a range of about 10 to 150 μm according to the application. The surface of the second film on which the resin layer is provided may be subjected to release treatment. In addition, when the second film is peeled off, the adhesive force between the resin layer and the second film is preferably smaller than the adhesive force between the resin layer and the first film.

As a film to which the resin composition of the present invention is applied in the production of a dry film, either the first film or the second film may be used.

### 3. Cured Product

The cured product of the present embodiment is obtained by curing the resin composition of the present embodiment or the resin layer of the dry film of the present embodiment.

The curing method is not particularly limited, and curing may be performed by a conventionally known method, for example, curing may be performed by heating at 150 to 230° C. The method for obtaining a cured product from the resin composition is not particularly limited, and can be appropriately changed according to the composition of the resin composition. As an example, after a step of applying (for example, application by an applicator or the like) the resin composition on a substrate on which a circuit pattern is formed is performed, a drying step of drying the resin composition is performed as necessary, and a thermal curing step of thermally crosslinking the polyphenylene ether by heating (for example, heating by an inert gas oven, a hot plate, a vacuum oven, a vacuum press machine, or the like) may be performed. The implementation conditions (for example, coating thickness, drying temperature and time, heating temperature and time, and the like) in each step may be appropriately changed according to the composition, application, and the like of the resin composition.

In addition, when a cured product is obtained using a dry film with a three-layer structure in which a resin layer is sandwiched between a first film and a second film, a printed wiring board can be produced by the following method. A thermal curing step of peeling off the second film from the dry film, heating and laminating the resin layer on the substrate on which the circuit pattern is formed, and then thermally curing the resin layer is performed. The thermal curing step may be cured in an oven or by a hot plate press. When the substrate on which the circuit is formed and the dry film of the present invention are laminated or hot-plate pressed, a copper foil or the substrate on which the circuit is formed can be laminated simultaneously. A printed wiring board can be produced by forming a pattern or a via hole by laser irradiation or a drill at a position corresponding to a predetermined position on the substrate on which the circuit pattern is formed to expose the circuit wiring. At this time, in a case where there is a component that has not been removed and remains on the circuit wiring in the pattern or the via hole (smear), a desmear treatment is performed. The first film may be peeled off after lamination, after thermal curing, after laser processing, or after desmear treatment.

### EXAMPLES

Next, the present invention will be described in detail with reference to Examples and Comparative Examples, but the present invention is not limited thereto at all.

<Synthesis of Branched Polyphenylene Ether (a)>

To a 500 mL separable flask, 19.8 g (0.16 mol) of 2,6-dimethylphenol and 2.42 g (0.018 mol) of 2-allylphenol were added, and the resulting mixture was dissolved in 261 g of toluene. Furthermore, di-μ-hydroxo-bis [(N,N,N′,N′-tetramethylethylenediamine) copper (II)]chloride and (Cu/TMEDA) tetramethylethylenediamine (TMEDA) were adjusted to be 0.18 wt % and 0.16% by mass, respectively, and the mixture was stirred at a stirring speed of 200 rpm using a four-blade paddle impeller and reacted at 40° C. for a predetermined time while blowing dry air into the reaction liquid at a flow rate of 75 mL/min to obtain a reaction liquid containing polyphenylene ether. After stopping the heating of the reaction liquid and blowing of dry air, di-μ-hydroxo-bis [(N,N,N′,N′-tetramethylethylenediamine) copper (II)]chloride (Cu/TMEDA) was removed by filtration, reprecipitated with a mixed liquid of 1,200 mL of methanol, 4.0 mL of concentrated hydrochloric acid and 27.0 ml of water, taken out by reduced pressure filtration, washed with methanol, and then dried at 80° C. for 24 hours to obtain a reactive branched polyphenylene ether. The obtained reactive branched polyphenylene ether (branched PPE) had a number average molecular weight (Mn) of 14,000 and a weight average molecular weight of 38,000 (Mw).

The number average molecular weight (Mn) and weight average molecular weight (Mw) of the branched PPE were determined by gel permeation chromatography (GPC). In GPC, Shodex K-805L was used as a column, the column temperature was 40° C., the flow rate was 1 mL/min, the eluent was chloroform, and the standard substance was polystyrene.

### <Synthesis of Other Curing Agent Component: Synthetic PPE (Unbranched)>

To a 500 mL separable flask, 2.28 g of bisphenol A and 100 g of 2,6-dimethylphenol were added, and the resulting mixture was dissolved in 261 g of toluene. Furthermore, di-μ-hydroxo-bis [(N,N,N′,N′-tetramethylethylenediamine) copper (II)]chloride (Cu/TMEDA) and tetramethylethylenediamine (TMEDA) were adjusted to be 0.18% by mass and 0.16 wt %, respectively, and the mixture was stirred at a stirring speed of 200 rpm using a four-blade paddle impeller and reacted at 40° C. for a predetermined time while blowing dry air into the reaction liquid at a flow rate of 75 mL/min to obtain a reaction liquid containing polyphenylene ether. After stopping the heating of the reaction liquid and blowing of dry air, di-μ-hydroxo-bis [(N,N,N′,N′-tetramethylethylenediamine) copper (II)]chloride (Cu/TMEDA) was removed by filtration, reprecipitated with a mixed liquid of 1,200 mL of methanol, 4.0 mL of concentrated hydrochloric acid and 27.0 mL of water, taken out by reduced pressure filtration, washed with methanol, and then dried at 80° C. for 24 hours to obtain unmodified PPE with Mn=10,000 (PDI=4) as polyphenylene ether.

To a 1 L two-necked recovery flask equipped with a dropping funnel were added 50 g of the unmodified PPE, 2.25 g of 4-chloromethylstyrene as a compound for modification, 3 g of tetrabutylammonium bromide as a phase transfer catalyst, and 500 mL of toluene, and the mixture was heated and stirred at 75° C. 15 mL of an 8 M aqueous sodium hydroxide solution was added dropwise to the solution over 20 minutes. Thereafter, the mixture was further stirred at 75° C. for 5 hours. Next, the reaction solution was neutralized with hydrochloric acid, then reprecipitated in 5 L of methanol, and taken out by filtration, washed 3 times with a mixed solution of methanol and water in a mass ratio of 80:20, and then dried at 80° C. for 24 hours to obtain modified PPE (synthetic PPE). The resulting synthetic PPE is unbranched PPE.

The number average molecular weight (Mn) of the synthetic PPE was determined by gel permeation chromatography (GPC). In GPC, Shodex K-805L was used as a column, the column temperature was 40° C., the flow rate was 1 mL/min, the eluent was chloroform, and the standard substance was polystyrene.

### <Preparation of Resin Composition>

### Example 1

1.60 g (100 parts by mass) of the branched PPE was completely dissolved by adding 9.7 g of anisole as a solvent and thoroughly stirring the mixture with a planetary centrifugal mixer. To the branched PPE resin solution thus obtained, 0.48 g (30 parts by mass) of triallyl isocyanurate (manufactured by Mitsubishi Chemical Corporation: trade name “TAIC”) as a curing agent component, 0.64 g (40 parts by mass) of BVPE (manufactured by Shandong Xingshun New Material Co., Ltd., trade name: “1,2-bis(4-vinylphenyl) ethane”), and 2.64 g (160 parts by mass) of spherical silica slurry (manufactured by Admatechs Company Limited, trade name: “SC2050-HNF”, solid content concentration: 70%) were each added, and the mixture was stirred with a planetary centrifugal mixer. Finally, 48 mg (3 parts by mass) of a,a′-bis(t-butylperoxy-m-isopropyl)benzene (manufactured by NOF CORPORATION: trade name “PERBUTYL P40”) as a radical polymerization initiator was added, and the mixture was thoroughly stirred with a planetary centrifugal mixer, thereby obtaining a varnish of a resin composition of Example 1.

### Examples 2 to 6, Comparative Examples 1 to 6

The same procedure as in Example 1 was carried out except that the components and the contents were changed to the values shown in Table 1 below to obtain varnishes of resin compositions according to Examples 2 to 6 and Comparative Examples 1 to 6.

<Preparation of test sample substrate>

### (Preparation Step of CZ-Treated Substrate)

Both surfaces of a substrate (copper-clad laminate, manufactured by MITSUBISHI GAS CHEMICAL COMPANY, INC., CCL-HL832NX, TYPE A Series, thickness 0.4 mm) were subjected to a roughening treatment using a roughening agent (manufactured by MEC COMPANY LTD.: trade name “CZ8100”) under such conditions that the etching amount was about 1 μm, thereby preparing a CZ-treated substrate.

### (Step of Preparing Dry Film)

The varnish of the resin composition of each of Examples and Comparative Examples was applied onto a 38 μm-thick extremely smooth grade PET film (manufactured by Toray Industries, Inc.: trade name “R80”) as a first film using an applicator so that the thickness after drying was a value shown in 35 μm, and then dried in a hot air circulation drying furnace at 90° C. for 15 minutes to obtain a test dry film of each of Examples and Comparative Examples.

### (Lamination/Curing Step)

The test dry film of each of Examples and Comparative Examples was disposed so that the resin layer of the dry film was in contact with both surfaces of the CZ-treated substrate obtained by the above-described procedure. The test dry film was laminated using a vacuum laminator (“CVP-600” manufactured by Nikko-Materials Co., Ltd.) at 140° C. and 0.8 MPa, and then the air was completely purged with nitrogen using an inert oven, heated to 200° C., and cured by heating for 60 minutes to prepare a test substrate including a cured product of each resin layer.

### (Desmear Step)

The surface of each test substrate was subjected to a desmear treatment using a commercially available desmear treatment liquid. Specifically, the test substrate from which the first film had been peeled off was immersed in a swelling liquid (manufactured by Atotech Japan K.K.,: trade name “Swelling Dip Securiganth P”) at 60° C. for 5 minutes, then immersed in a roughening liquid (manufactured by Atotech Japan K.K.,: trade name “Concentrate Compact CP”) at 80° C. for 20 minutes, and then immersed in a neutralizing liquid (manufactured by Atotech Japan K.K.,: trade name “Reduction Securiganth P500”) at 40° C. for 5 minutes.

### (Plating Layer Forming Step)

An electroless plating treatment and an electrolytic plating treatment were performed on the surface of each test substrate subjected to the desmear step to form a copper plating layer. Specifically, as the electroless plating treatment, electroless copper plating was performed by immersion in a cleaner treatment liquid (manufactured by C.Uyemura & Co., Ltd.: trade name “Cleaner MCD-PL”) at 40° C. for 5 minutes, immersion in a soft etching treatment liquid (manufactured by C.Uyemura & Co., Ltd.: trade name “ALCUP MDP-2”) at 25° C. for 2 minutes, immersion in a catalyst-imparting treatment liquid (manufactured by C.Uyemura & Co., Ltd.: trade name “ALCUP MAT-SP”) at 40° C. for 5 minutes, immersion in a reducing treatment liquid (manufactured by C.Uyemura & Co., Ltd.: trade name “ALCUP MRD-2-C/MAB-4-C/MAB-4-A”) at 35° C. for 3 minutes, and immersion in a reaction promoting treatment liquid (manufactured by C.Uyemura & Co., Ltd.: trade name “ALCUP MEL-3-A”) at 25° C. for 1 minute, and immersion in an electroless plating treatment liquid (manufactured by C.Uyemura & Co., Ltd.: trade name “THRU-CUP PEA V2”) at 36° C. for 20 minutes. Thereafter, as the electrolytic plating treatment, electrolytic copper plating was performed under the conditions of a current density of 2 A/dm2 by immersion in an acid washing solution (manufactured by Atotech Japan K.K.: trade name “acidic cleaner FR”) at 45° C. for 5 minutes, immersion in a 10% sulfuric acid aqueous solution at 25° C. for 1 minute, and immersion in an electrolytic copper plating solution at 23° C. for 60 minutes. Finally, as annealing treatment, heat treatment was performed at 190° C. for 60 minutes in a hot air circulation drying furnace. A test sample substrate of each of Examples and Comparative Examples was obtained by the above preparation method.

### <Preparation of Test Cured Film>

The test dry film of each of Examples and Comparative Examples was laminated using a vacuum laminator (“CVP-600” manufactured by Nikko-Materials Co., Ltd.) at 140° C. and 0.8 MPa so that the resin layer of the dry film was in contact with a smooth copper foil. Thereafter, the air was completely purged with nitrogen using an inert oven, heated to 200° C., and cured by heating for 60 minutes, the first film was peeled off, and the copper foil was etched, thereby obtaining a test cured film.

### <Evaluation of Film Formability>

The test cured film of each of Examples and Comparative Examples prepared in <Preparation of test cured film> described above was observed and evaluated according to the following criteria.

### (Evaluation Criteria)

A: The cured film is uniform.

C: The cured film is non-uniform or collapsed during etching of the copper foil.

### <Measurement and Evaluation of Coefficient of Thermal Expansion (CTE)>

The test cured film of each of Examples and Comparative Examples prepared in <Preparation of test cured film> described above was cut out so as to obtain a measurement size (size of 3 mm×30 mm), and the CTE was measured with TMA (Thermomechanical Analysis) Q400 manufactured by TA Instruments Japan Inc. The temperature was raised from −50° C. to 300° C. at 10° C./min under a nitrogen atmosphere with a chuck distance of 16 mm and a load of 30 mN in a tensile mode, and then the temperature was lowered from 300° C. to −50° C. at 10° C./min and then raised again from −50° C. to 300° C. at 10° C./min to perform the measurement. The average linear coefficient of thermal expansion (CTE) from 50° C. to 100° C. at the second temperature rising was obtained.

### (Evaluation Criteria)

A: CTE (α1) of less than 25 ppm
B: CTE (α1) of 25 ppm or more and less than 50 ppm
C: CTE (α1) of 50 ppm or more
−: Not measurable

### <Measurement and Evaluation of Dielectric Loss Tangent (Df)>

The test cured film of each of Examples and Comparative Examples prepared in <Preparation of test cured film> described above was cut into a measurement size (size of 45 mm×80 mm), and the dielectric loss tangent (Df) was measured by an SPDR (Split Post Dielectric Resonator) method. As the measuring instrument, a vector network analyzer E5071C manufactured by Key Site Technologies and an SPDR and a calculation program manufactured by QWED Inc. were used. The measurement conditions were a frequency of 10 GHz and a measurement temperature of 25° C.

### (Evaluation Criteria)

A: Df of 0.0020 or less
B: Df of more than 0.0020 and less than 0.0040
C: Df of 0.0040 or more
−: Not measurable

### <Evaluation of Plating Swelling>

The surface of the test sample substrate of each of Examples and Comparative Examples prepared in the (Plating layer forming step) described above after plating layer formation was visually confirmed to evaluate plating swelling. The ratio of the area where the plating layer was swollen on both sides of the substrate was calculated and evaluated according to the following evaluation criteria.

### (Evaluation Criteria)

A: Ratio of the area where swelling occurred of less than 5%
C: Ratio of the area where swelling occurred of 5% or more
−: Not measurable

TABLE 1

| | | | Example | | | | | | Comparative Example | | | | | |
|---|---|---|---|---|---|---|---|---|---|---|---|---|---|---|
| | | | 1 | 2 | 3 | 4 | 5 | 6 | 1 | 2 | 3 | 4 | 5 | 6 |
| Blended | (A) Branched PPE | Branched PPE*¹ | 100 | 100 | 100 | 100 | 100 | 100 | 100 | 50 | 100 | — | — | 100 |
| components | Linear PPE | SA9000*² | — | — | — | — | — | — | — | 50 | — | 100 | | — |
| | Crosslinking aid | TAIC*³ | 30 | 50 | — | — | — | — | 60 | 30 | — | 30 | 30 | — |
| | | TVCH*⁴ | — | — | — | — | — | — | — | — | 70 | | | — |
| | (B) Curing agent | BVPE*⁵ (Mn: 234) | 40 | 10 | 40 | — | — | — | — | — | — | 40 | 40 | — |
| | component | Divinylbenzene*⁶ | — | — | — | 50 | — | — | — | — | — | — | — | — |
| | (Mn ≤ 2,500) | (Mn: 130) | | | | | | | | | | | | — |
| | | OPE- 2 St-1200*⁷ | — | — | — | — | 50 | — | — | — | — | — | 100 | — |
| | | (Mn: 1,200) | | | | | | | | | | | | — |
| | | OPE-2 St-2200*⁸ | — | — | — | — | — | 50 | — | — | — | — | — | — |
| | | (Mn: 2,200) | | | | | | | | | | | | — |
| | Other curing agent | Synthetic PPE*⁹ | — | — | — | — | — | — | — | — | — | — | — | 50 |
| | component | (Mn: 10,000) | | | | | | | | | | | | |
| | (Mn ≥ 2,500) | | | | | | | | | | | | | |
| | Elastomer | H1051*¹⁰ | — | — | — | — | — | — | 25 | — | — | — | — | — |
| | (C) Radical polymerization | PERBUTYL P40*¹¹ | 3 | 3 | 3 | 3 | 3 | 3 | 3 | 3 | 3 | 3 | 3 | 3 |
| | initiator | | | | | | | | | | | | | |
| | (D) Filler | SC2050-HNF*¹² | 115 | 109 | 95 | 102 | 102 | 102 | 125 | 89 | 115 | 115 | 115 | 102 |

| | | | | | | | | | | | | | |
|---|---|---|---|---|---|---|---|---|---|---|---|---|---|
| Evaluation | Film formability | A | A | A | A | A | A | A | A | C | C | C | A |
| results | Coefficient of thermal expansion (CTE) | A | A | A | B | B | B | C | C | — | — | — | C |
| | Dielectric loss tangent (Df) | A | A | A | A | A | B | A | C | — | — | — | B |
| | Plating swelling | A | A | A | A | A | A | A | C | — | — | — | C |

Details of each component in Table 1 are shown below. The blending amount of each component is parts by mass, and is a value in terms of solid content.

### <(A) Branched PPE>

1: Branched PPE described above

### <Linear PPE>

2: Linear PPE {manufactured by SHPP Japan LLC: trade name “SA9000”}
   <Crosslinking aid>
3: Triallyl isocyanurate {manufactured by Mitsubishi Chemical Corporation: trade name “TAIC”}
4: Trivinylcyclohexane (TVCH) {manufactured by Shandong Xingshun New Material Co., Ltd.: trade name “1,2,4-Trivinylcyclohexane”}

### < (B) Curing Agent Component>

5:1,2-Bis(vinylphenyl) ethane (BVPE) {manufactured by Shandong Xingshun New Material Co., Ltd., trade name: “1,2-bis(4-vinylphenyl) ethane”, molecular weight (Mn): 234}
6: Divinylbenzene {manufactured by NIPPON STEEL Chemical & Material Co., Ltd.: trade name “divinylbenzene”, molecular weight (Mn): 130}
7: Oligophenylene ether compound with terminal styrene {manufactured by MITSUBISHI GAS CHEMICAL COMPANY, INC.: trade name “OPE-2St-1200”, molecular weight (Mn): 1,200}
8: Oligophenylene ether compound with terminal styrene {manufactured by MITSUBISHI GAS CHEMICAL COMPANY, INC.: trade name “OPE-2St-2200”, molecular weight (Mn): 2,200}

### <Other Curing Agent Components>

*9: Synthetic PPE described above {molecular weight (Mn): 10,000}

### <Elastomer>

*10: Elastomer {manufactured by Asahi Kasei Corporation: trade name “Tuftec H1051”}

### (C) Radical Polymerization Initiator>

11: α,α′-Bis(t-butylperoxy-m-isopropyl)benzene {manufactured by NOF CORPORATION: trade name “PERBUTYL P40”}

### <(D) Filler>

12: Silica slurry, solid content 70% by mass, dispersion medium cyclohexanone {manufactured by Admatechs Company Limited: trade name “SC2050-HNF”}

### INDUSTRIAL APPLICABILITY

The resin composition, the dry film, and the cured product of the present invention have excellent film formability and can suppress plating swelling while maintaining low dielectric properties and low thermal expansion rate, and thus can be used as an interlayer insulating material or the like of a printed wiring board built in an electronic device.

What is claimed is:

1. A resin composition comprising:
(A) a branched polyphenylene ether;
(B) a curing agent component;
(C) a radical polymerization initiator; and
(D) a filler, wherein
the curing agent component (B) has two or more styrene double bonds and has a molecular weight of 2,500 or less.

2. The resin composition according to claim 1, wherein the curing agent component (B) has two or more styrene double bonds, and the curing agent component (B) has a molecular weight of 200 to 1,500.

3. The resin composition according to claim 1, wherein the curing agent component (B) has two styrene double bonds, and the curing agent component (B) has a molecular weight of 200 to 1,500.

4. The resin composition according to claim 1, wherein the curing agent component (B) is a compound represented by the following formula (1): 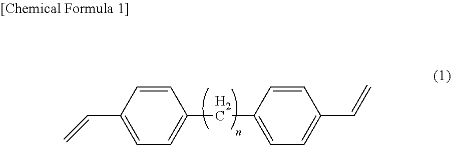
wherein n is an integer of 1 to 10.

5. A dry film comprising a resin layer formed of the resin composition according to claim 1.

6. A cured product obtained using the resin composition according to claim 1.

7. A cured product obtained using the resin layer of the dry film according to claim 5.
